(19) United States
(12) Patent Application Publication
(10) Pub. No.: US 2026/0220185 A1
(43) Pub. Date: Jul. 30, 2026

(54) Adaptive Query Response System Using Dynamic Language Model Evaluation, Selection, and/or Alignment

(71) Applicant: Oracle International Corporation, Redwood Shores, CA (US)

(72) Inventors: Priyaranjan Pattnayak, Snohomish, WA (US); Amit Agarwal, Seattle, WA (US); Hussain Bohra, Chicago, IL (US)

(73) Assignee: Oracle International Corporation, Redwood Shores, CA (US)

(21) Appl. No.: 19/041,255

(22) Filed: Jan. 30, 2025

(51) Int. Cl. G06F 16/358; G06F 16/355

(52) U.S. Cl. CPC G06F 16/358; G06F 16/355

(57) ABSTRACT

Techniques for evaluating a language model are disclosed herein. One or more agents and/or one or more language models are used to generate responses to queries in conversations. For example, during chat session conversations, the agent and/or model used to generate responses to queries in the conversation is sometimes changed. Various metrics are collected for the conversations for which a prompt, agent or model change occurs and/or the conversations for which a change to the prompt, agent and/or model does not occur. Metrics such as success rate, escalation rate, query repetition, direct feedback, or other feedback is collected and/or aggregated for groups of users and/or topics of conversations. One or more models used to generate responses in the conversations are evaluated and/or selected based on the metrics.

### TECHNICAL FIELD

The present disclosure relates to techniques for a query response system.

### BACKGROUND

Large language models are used in various contexts to produce answers to queries and other responses to different prompts. For example, chatbots, agents, or other language model systems deploy large language models to generate natural language responses to user queries. However, traditional language models sometimes provide inaccurate, irrelevant, misaligned or otherwise invalid responses to some queries. Further, traditional systems fail to adapt when a response does not answer a query. Traditional query response systems may repeat the same mistakes and/or will not be able to provide a valid answer to the query.

Techniques in this disclosure may address any of the aforementioned flaws, challenges, and difficulties by providing techniques that result in improved security for model output. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an adaptive query response system, in accordance with one or more embodiments;

FIG. 2 illustrates example operations for adaptive query response, in accordance with one or more embodiments;

FIGS. 3a-e illustrate example techniques for adaptive query response, in accordance with one or more embodiments;

FIG. 4 illustrates an example machine learning engine, in accordance with one or more embodiments;

FIG. 5 illustrates example operations for machine learning, in accordance with one or more embodiments; and

FIG. 6 illustrates a block diagram of a computer system, in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. ADAPTIVE QUERY RESPONSE SYSTEM
3. ADAPTIVE QUERY RESPONSE OPERATIONS
4. EXAMPLE TECHNIQUES FOR ADAPTIVE QUERY RESPONSE
   i. Overview of Example Techniques
   ii. Metrics for User Groups
   iii. Parallel Agents for User Experience Improvement
   iv. Parallel Agents for Evaluating Improvement
   v. Parallel Agents for Evaluating Regression
   vi. Human Agent Alignment
5. MACHINE LEARNING ARCHITECTURE
6. MACHINE LEARNING OPERATIONS
7. GENERATIVE ARTIFICIAL INTELLIGENCE MODELS
8. COMPUTER NETWORKS AND CLOUD NETWORKS
9. MICROSERVICE APPLICATIONS
10. HARDWARE OVERVIEW
11. MISCELLANEOUS; EXTENSIONS

### 1. General Overview

Embodiments herein include an adaptive query response system using dynamic language model evaluation, selection, and/or alignment.

In embodiments, a query response system adapts to queries or other input during a conversation. The system adapts to an input query by selecting or changing one or more models used to answer the query according to various properties of the response. For example, if an input into a client of a chatbot repeats a question or includes negative feedback for a previous answer generated by a first model, then the system uses a second prompt, a second model and/or a second agent to generate the subsequent answer in the chatbot conversation. In embodiments, a first model generates a first answer, and a second answer is generated by a second model (or one or more additional models). Based on direct feedback and/or feedback determined from the query and/or previous queries, the response to the query presented in the conversation is based on a selection of the first answer and the second answer. In embodiments, an answer is selected by default and another answer is selected based on a condition or conditions being met. For example, a default model changes responsive to the polarity (e.g., positive or negative) and/or quantity (e.g., one instance, two instances) of feedback. In various examples, feedback is direct positive or negative feedback and/or is feedback inferred from one or more queries. The feedback is used to determine whether a condition is met and whether a first model or a different model should be used to respond to subsequent input queries in the conversation.

In some embodiments, the system determines metrics for a plurality of queries and/or conversations. For example, a number of queries and/or conversations is determined for which one or more language models resolves the query or conversation, and/or a receives positive feedback for the query or conversation. Also, the system determines a number of queries and/or conversations is for which the conversation is escalated, or negative feedback is received. In embodiments, the system determines the numbers of queries resolved or escalated by models of a plurality of language models and compares the models based on such metrics. In some embodiments, the system selects a language model based on the numbers of queries resolved or escalated (or based on the feedback).

Applicant notes that this Overview is non-limiting in nature, and that additional embodiments and related combinations of features are described in this Specification and/or recited in the claims.

### 2. Adaptive Query Response System

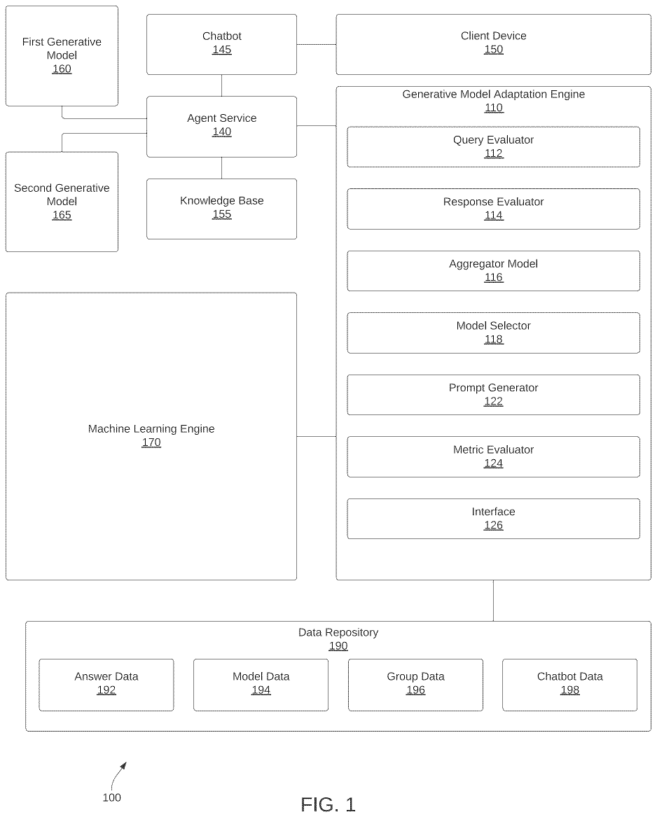

FIG. 1 illustrates an example adaptive query response system 100 using dynamic language model evaluation, selection and/or alignment. As shown, the system 100 includes a generative model adaptation engine 110, an agent service 140, a chatbot 145 connected to a client device 150, a knowledge base 155 accessible by the agent service 140, a first generative model 160 accessible by the agent service 140, a second generative model 165 accessible by the agent service 140, a machine learning engine 170, and a data repository 190.

In FIG. 1, the generative model adaptation engine 110 includes a query evaluator 112, a response evaluator 114, an aggregator model 116, a model selector 118, a prompt generator 122, a metric evaluator 124, and an interface 126. The generative model adaptation engine 110 analyzes and/or evaluates queries provided to the chatbot and/or responses that are generated by the system. In various embodiments, the system randomly switches from the first generative model 160 to the second generative model 165 and/or from the second generative model 165 to the first model 160 or to another model. In embodiments, the system switches models based on the query repeating a question, indicating negative feedback, indicating a negative tone, being related to a particular topic, etc. For example, the generative model adaptation engine 110 signals the agent service 140 to switch generative models based on feedback and/or random chance.

The query evaluator 112 includes components that analyze incoming queries to determine if the query contains negative feedback or feedback indicating that a model being used to by the chatbot to generate an answer the query has not generated an answer to the query that has been accepted by the user. For example, the query evaluator 112 consists of mechanisms for parsing information from natural language input such as by extracting key features and/or by assessing the query for topic, intention, tone, and/or the like. Examples of these mechanisms include tokenization algorithms, semantic analysis modules, and query classification frameworks that contribute to a comprehensive understanding of the query. The evaluator parses the query (or other user input) and determines whether one or more criteria are met such as: direct negative feedback, negative tone, repeated question, topic outside scope of a first model, etc. For example, a criterion is met if a subsequent query repeats the same or a similar question, indicating that an answer was not accepted. In embodiments, the query evaluator 112 provides the parsed information about the query to the model selector 118 and/or the prompt generator 122.

In some embodiments, multiple models are deployed, and the query evaluator 112 determines a model selection based on an evaluation of the contents and/or context of a query. In this example the output from a first model is used to generate responses to initial queries, and the query evaluator determines whether output from another model should be used to generate responses for a present or subsequent query using a specified model different than the first.

For example, the query evaluator includes components that measure various attributes of a conversation and/or a query. For example, based on an evaluation of a query that is subsequent to a response, the system determines a metric about the response. For example, if the query repeats a question, the system identifies the repeated question as negative feedback. On the other hand, if the query changes topics, the system determines the answer was accepted (i.e., based on the conversation ending before a topic associated with the answer is referenced again in a subsequent query).

The response evaluator 114 is configured to assess the quality, relevance, and coherence of responses generated by the system. The response evaluator 114 includes algorithms for comparing the model output against predefined metrics or standards, such as natural language evaluation techniques, and/or validity checks. The response evaluator 114 analyses, scores, and/or classifies a particular response based on user input, such as direct feedback, indirect feedback, or inferred feedback. In some embodiments, the response evaluator 114 includes components to check responses against previous user feedback and/or for alignment with previous responses. Implementations of the response evaluator 114 use various scoring systems, heuristic rules, and/or machine learning models. In some cases, the response evaluator 114 determines that a new response should be generated and provides an evaluation of the response to the prompt generator 122 and/or the model selector 118.

In an example, the response evaluator 114 determines a different model should be selected and provides this information to the model selector 118. In some embodiments, a plurality of models are prompted responsive to a particular query. In this example, the model selector 118 selects an output from a plurality of output generated by the plurality of models. Responsive to the response evaluator 114 determining one or more responses by a particular model are receiving a poor evaluation (e.g., are exceeding an escalation rate threshold), the model selector 118 does not select output generated by the particular model and/or does not select the particular model to be prompted. The response evaluator 114 evaluates a response based on comparison to ground truth and/or based on direct or indirect feedback.

In another example, the response evaluator determines that a different prompt for a model should be generated and provides this information to the prompt generator 122. In embodiments, the response evaluator 114 uses response ranking modules and/or error-checking layers. The response evaluator 114 also includes filters or other components to check responses for redundancies and/or evaluate phrasing for consistency or alignment.

The aggregator model 116 aggregates conversations into groups based on various attributes of the conversation such as topic, resolution status, user type (client, expert, customer, administrator, test, etc.), service type (technical support, customer service support, sales support, third-party support, record retrieval, etc.), language, escalation status (not escalated-resolved, escalated-resolved, escalated-not resolved, etc.), or the like. In embodiments, the aggregator model 116 performs clustering on a plurality of conversations to determine, based on an attribute of the conversation, a cluster of conversations that have the attribute. The system compares one or more metrics for the conversations in the cluster to identify a model (e.g., the first model 160, the second model 165, or another model) having the best performance for one or more metrics (e.g., lowest regression rate, lowest escalation rate, highest solution rate, highest positive feedback rate, lowest negative feedback rate, etc.).

The model selector 118 comprises a control mechanism that determines which generative model(s) the agent service 140 will deploy in response to a query received by the chatbot 145. In some embodiments, the model selector 118 selects a generative model and/or an agent model at random or based on contents or attributes of a query. For example, the model selector 118 includes criteria-based systems, decision trees, and/or adaptive algorithms that consider the query's evaluated features, prior user interactions, and/or metrics collected by the system. In embodiments, the model selector 118 utilizes the information from the query evaluator 112 and/or the response evaluator 114 to select a model.

In embodiments, the model selector 118 uses random selection. The model selector includes components for maintaining and/or adjusting probabilities for individual models and/or for combinations of individual models and attributes of a query or conversation. For example, a chance value for a particular model being randomly selected is increased based on positive feedback for the model being received in a subsequent input from a user. Also for example, a chance value for a model is increased based on the subsequent query being null, and/or on no subsequent query being received from the user in the conversation (i.e., such as if the answer were accepted). Some implementations of the model selector 118 feature real-time analytics engines, rules-based systems, and/or learning mechanisms.

The prompt generator 122 includes modules used to create and/or modify prompts for one or more generative models. In various examples, the prompt generator 122 includes template libraries, contextual enhancement modules, and/or pre-processing scripts that shape the input given to a particular model based on features of the model and/or based on metrics collected for conversations in which content generated by the model was used. In embodiment, the prompt generator includes a language model core configured for generating one or more prompts that are respectfully configured for one or more generative large language models.

The metric evaluator 124 includes statistical analysis tools, performance tracking dashboards, and benchmarking frameworks to assess aspects like response accuracy, speed, and user satisfaction for one or more particular queries, conversations, topics, user types, and/or models. These metrics are used to generate actionable insights that inform optimization. The metrics are used to compare model performance between the first generative model 160 and the second generative model 165 (and/or another model) for a query group.

The metric evaluator identifies groups for which a model does not meet a threshold for accuracy, efficacy, alignment, quality, and/or the like. The metric evaluator identifies a model having a highest metric for a group. In some embodiments, the metric evaluator facilitates a visualization of attributes of conversations, queries, topics, or users, etc. Implementations leverage data visualization software, predictive analytics models, and/or machine learning techniques that enable continual improvement and/or feedback-driven updates. Metric evaluation data is used for various analytics operations and is visualized using sophisticated software to render the data in two or more dimensions in an interactive format that can be reorganized, filtered, and/or sorted based on a metric.

The agent service 140 comprises a software or system component that facilitates the integration and coordination of generative models within a query response system. The agent service 140 is structured to manage the selection, deployment, and monitoring of model activities in real-time. It incorporates modules for evaluating query characteristics, processing model responses, and implementing feedback mechanisms to adjust model selection. Physical or virtual instances of the agent service 140 include servers, networking components, memory, interfaces and/or other components.

The chatbot 145 represents an interactive interface designed for user engagement through text-based or voice-based communication. For example, a chatbot 145 consists of a front-end user interaction layer, which can include natural language understanding (NLU) and natural language generation (NLG) capabilities, as well as a backend that connects to one or more agents or generative models. Specific embodiments of the chatbot 145 may include a graphical interface on web applications, integrations within messaging platforms, voice-activated systems, or the like. These components enable the chatbot 145 to interpret user queries and deliver structured responses.

The client device 150 refers to a hardware device utilized by an end-user to interact with the chatbot 145. The client device 150 can take the form of various embodiments, such as a smartphone, tablet, laptop, or desktop computer. It includes components for data transmission, such as wireless or wired connectivity modules, and interfaces for user input and output, like touchscreens, keyboards, microphones, and speakers. The operating systems and applications within the client device 150 support the execution of chatbot interactions, rendering responses, and managing the data exchanged during communication sessions.

The knowledge base 155 encompasses a structured repository of information utilized to support the generation of accurate and relevant responses. For example, a knowledge base 155 is composed of curated data sets, relational databases, semantic networks, and/or collections of documents that the query response system references. This information provides contextual accuracy and enhances the system's understanding of complex queries. Examples of data contained within the knowledge base 155 include industry-specific terminologies, user manuals, and/or previously resolved inquiry records. Data contained in knowledge bases are formatted in ways that facilitate efficient retrieval and relevance ranking. For example, one type of knowledge base is a vector database that facilitates efficient retrieval and relevance ranking.

The first generative model 160 is a machine learning model designed to generate responses based on predefined parameters and/or training datasets. For example, the first generative model 160 a large language model (LLM). In general, an LLM is trained using deep learning architectures, such as transformer networks, which process large amounts of textual data to enable the model to produce coherent and contextually appropriate answers. In various examples, a first model is a default or is selected when an initial query is received. In other embodiments, a model is selected based on initial query characteristics, user characteristics, source characteristics, and/or another criterion.

The second generative model 165 refers to a distinct machine learning model. In some embodiments, the second generative model 165 is a fine-tuned version of the first generative model 160. In embodiments, the second generative model 165 is optimized (or fine-tuned) for a particular topic, task, user type, or other criterion. For example, the second generative model 165 features a similar or alternate neural architecture compared to the first model but is trained on supplementary or specialized datasets.

The second generative model 165 is used to generate response content for the chatbot 145 instead of the first generative model 160 responsive to one or more conditions. In some cases, there is a random chance of the model used to generate the answer switching from the first generative model 160 to the second generative model 165 for one or more queries in a conversation. In some examples, the switch is triggered when the first model's output is insufficient, when user feedback indicates negative feedback or a need for a different approach, or when a question is repeated.

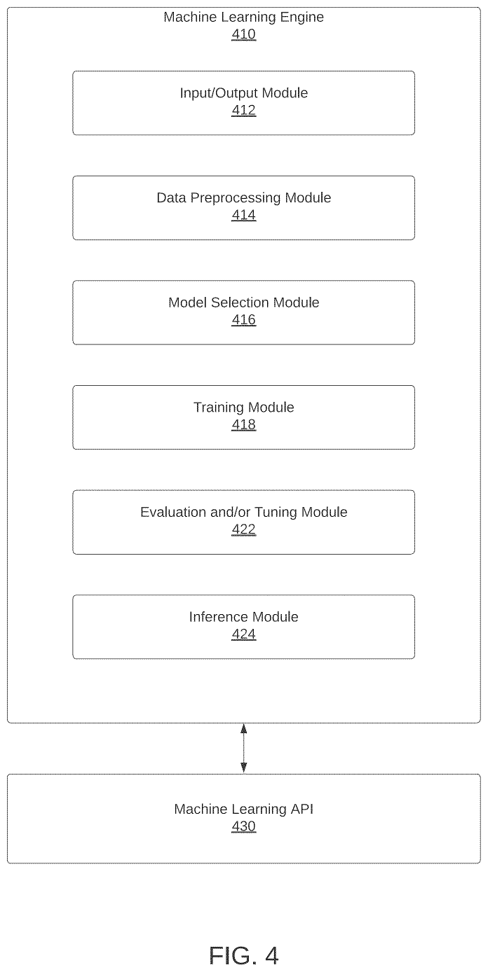

In embodiments, the machine learning engine 170 is similar to or the same as the example machine learning engine 410, which is explained in more detail below with regard to FIG. 4, below.

In one or more embodiments, the adaptive query response system 100 includes one or more interfaces. For example, interface 126 refers to hardware and/or software configured to facilitate communication between a system and another device, and/or between a system and a user. In FIG. 1, the interface 126 is used to facilitate communication between the components of the system 100, and/or one or more client computing devices. Such an interface renders user interface elements and receives input via user interface elements. Examples of interfaces include a graphical user interface (“GUI”), a command line interface (“CLI”), a haptic interface, and a voice command interface. Examples of user interface elements include checkboxes, radio buttons, dropdown lists, list boxes, buttons, toggles, text fields, date and time selectors, command lines, sliders, pages, and forms. In various embodiments, different components of such an interface are specified in different languages. The behavior of user interface elements is specified in a dynamic programming language such as JavaScript. The content of user interface elements is specified in a markup language, such as hypertext markup language (“HTML”) or extensible markup language (“XML”) User Interface Language (“XUL”). The layout of user interface elements is specified in a style sheet language such as Cascading Style Sheets (“CSS”). Alternatively, interfaces may be specified in one or more other languages, such as Java, C, or C++.

Generally, the data repository 190 stores data loaded onto or generated by the system 100. The data repository 190 optionally stores data loaded from other sources. In various embodiments, the data repository 190 stores one or more types of data including, but not limited to answer data 192, model data 194, group data 196, and chatbot data 198.

In various embodiments, answer data 192 comprises data and/or metadata associated with answers, such as answer text, timestamp information and/or information about one or more parameters associated with the answer. Model data 194 comprises information and/or histories associated with one or more models, such as the first generative model 160 and/or the second generative model 165. Group data 196 comprises data associated with one or more of the groups identified by evaluating metrics associated with various conversations. The group data 196 includes conversation histories for group members, metrics, and information associated with metrics (e.g. trends, inferences, projections, etc.). Chatbot data 198 comprises stored conversations and other data associated with chatbot sessions, such as time information, user preferences, conversation parameters, settings, etc. One or more other data types are loaded onto the data repository 190 in various embodiments.

In an embodiment, the adaptive query response system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (“NAT”), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 3. Adaptive Query Response Operations

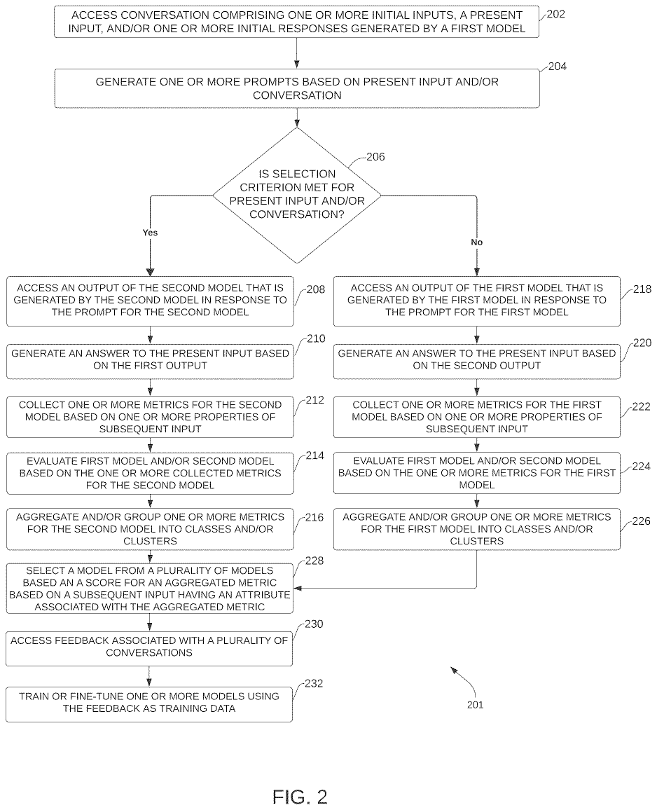

FIG. 2 illustrates example operations for a method 201 of adaptive query response using dynamic language model evaluation, selection and/or alignment. For example, the method 200 is performed by a system such as the adaptive query response system 100 of FIG. 1. In various embodiments, the generative model adaptation engine is an engine used to adapt an LLM or another generative model. For example, the generative model is an LLM used by an agent model to generate responses to queries received by the agent model. In some embodiments, a generative image model, a generative video model, or a multimodal model is used to generate images, video, computer code, and or other media in addition to or instead of an LLM being used to generate natural language.

In the example, an adaptation engine accesses a conversation comprising one or more initial inputs, a present input, and/or one or more initial responses generated by a first model (Operation 202). For example, the adaptation engine retrieves one or more portions of the conversation comprising a series of user queries and corresponding responses. In embodiments, the user queries have been previously generated during an interactive session that is facilitated by one or more agent models, retrieval models, an LLM, and/or one or more other generative models.

The adaptation engine generates one or more prompts based on the present input and/or the conversation (Operation 204). For example, the system generates a prompt for a first LLM used to generate the initial responses in the conversation. In another example, the system generates one or more prompts for one or more LLMs different than the first LLM in addition to or instead of the first LLM. In embodiments, one or more prompts comprise the input and/or any portion or all of the conversation. The adaptation engine processes the input to create the prompt. For example, the input is rephrased with contextual details or instructions that are agent-specific and/or model-specific such that the constructed prompt is tailored to optimize the performance of a particular model.

In some embodiments, a first agent model is used to generate prompts for a first LLM, whereas a second agent model is used to generate prompts for a second LLM. The system generates a first prompt for the first LLM and/or a second prompt for a second LLM. In some embodiments, the first LLM is a base LLM and the second LLM is a fine-tuned version of the base LLM. In embodiments the first LLM is an LLM of a first family of LLMs, and the second LLM is an LLM of a second family of LLMs.

The adaptation engine determines whether a selection criterion is met for the present input and/or the conversation (Operation 206). For example, as queries or other inputs are received in a conversation, an adaptation engine determines, for the inputs, whether one or more or the criterion are met based on the inputs and some or all of the previous conversation. For example, the adaptation engine determines the presence of direct or indirect feedback in the present input based on the contents of the present input as well as the initial inputs and responses in the conversation. For example, if a question or topic in the present input is included in the conversation (i.e., is repeated), if the present input is of a different tone (i.e., the input tone becomes frustrated or negative), and/or if direct feedback is received (e.g. the input includes feedback or states the previous response was unhelpful or invalid), etc., the conversation meets a criterion.

Various criteria include threshold numbers of different kinds of direct or inferred feedback. For example, one instance of direct feedback occurring is a criterion. However, two or more instances of indirect feedback is a criterion. Also for example, two instances of a repeated question is a criterion. However, three instances of a repeated topic is a criterion. In practice, any number or numbers of instances or occurrences are usable as criteria. Also, in embodiment, responsive to a conversation including repeated topics, the input is semantically analyzed to determine if the input requests different information or more detailed information associated with a topic. A condition includes that an input including a repeated topic does not count towards a criterion if the repeated topic is a first request for new details or different information associated with a topic.

In an embodiment, the adaptation engine randomly switches LLMs based on input received during a conversation using on a distribution or percentage chance for a first model and a second model. The conversation continues until the conversation is completed or escalated using the first model, or until the random chance results in the second model being used to respond to a particular input and/or subsequent input. In some embodiments, while the second model is being used, another random selection between the first model and the second model is made for a next subsequent input until the conversation is completed.

In embodiments, the adaptation engine accesses a plurality of conversations and collects a plurality of metrics for the plurality of conversations as follows: For conversations where no random switch occurs, one or more metrics comprising whether the conversation was resolved or escalated, positive or negative feedback, a number of repeated queries, and/or other metrics. One or more different metrics are also collected for conversations where a random switch has taken place. In embodiments, the metrics and the different metrics aggregated and/or are compared. The first model or the second model is selected based on comparing the aggregated metrics.

In some embodiments, the adaptation engine determines a model selection by analyzing the content of the input, such as by checking for specific keywords, identifying the sentiment or tone, or measuring the complexity of the input. For instance, an adaptation engine evaluates whether the input is a repeated query or contains negative feedback directed at the response provided by a first LLM. Techniques for making this determination involve rule-based analysis and/or applying pre-defined filters and/or rankings using keywords or semantic similarity. In some embodiments, a selection model selects a second LLM based on the content of the present input and/or the conversation.

If the criterion is met for the present input and/or the conversation, the adaptation engine accesses a first output of the second model that is generated by the second model in response to the prompt for the second model (Operation 208). Continuing the example, the adaptation engine selects the second LLM based on the conversation satisfying the criterion. The output is collected, stored, and/or prepared for further processing. The text produced by the second LLM is used as content of an answer to the present input in the conversation instead of text produced by the first LLM because the criteria is met.

The system generates an answer to the present input based on the output (Operation 212). For instance, the system combines or refines the first output to produce a polished and user-friendly answer. The first output is checked for alignment, consistency, and/or formatted for the conversation. The answer is then presented to the user in the conversation. In various embodiments, the user is or is not presented with an indication that a change in generative models has occurred. In some embodiments, the system generates a plurality of outputs using a plurality of different models. The answers of the plurality of answers are scored and/or checked for consistency, and a highest-scoring or most consistent answer of the plurality of answers is selected for being presented to the user in the conversation.

The system collects one or more metrics for the second model based on one or more properties of subsequent input (Operation 212). In various examples, the system gathers data points including a label for one or more of a sentiment, topic, context, or other attribute of the conversation. The system determines whether positive feedback or negative feedback is present in the input. The system determines whether the content of the query indicates success or failure. No subsequent query being received, or a subsequent query that is a different topic, is considered as positive feedback. Repeating a question is considered as negative feedback. This collected information is stored for subsequent evaluation, aggregation, and analysis.

The system evaluates the first model and/or the second model based on the one or more collected metrics for the second model (Operation 214). In an example, the system compares a metric for the second LLM to a metric for the first LLM (or another model), or to a standard for the metric type. For example, the system compares a success rate, an escalation rate, or a feedback rate metric for the first model and the second model. The system determines if the second LLM has a higher success rate or a lower escalation rate, or a rate higher or lower than a threshold (e.g., <1%, 5%, 15%, 50%, 85%, 95%, >99%, or another value). Responsive to the second LLM having a higher success rate or lower escalation rate, the second LLM is selected as an initial model for one or more subsequent conversations.

In embodiments, the system uses the collected metrics to assess aspects like the accuracy, relevance, and efficiency of the responses generated by the second LLM. Such an evaluation includes comparing the outputs to other models, comparing the outputs to predefined benchmarks, calculating performance scores, and/or performing statistical analyses to identify patterns or areas of improvement. The system can then use these insights to adjust parameters, refine training data, and/or make recommendations.

The system aggregates and/or groups the one or more metrics into classes and/or clusters (Operation 216). For example, the system uses the collected metrics to aggregate and/or correlate the one or more metrics for the conversation with one or more comparable metrics collected for one or more other conversations. These other conversations include responses having content generated by the first LLM, the second LLM, or another LLM. The system aggregates the conversations by LLM, input topics, etc., based on the metrics (e.g., direct feedback, indirect feedback, escalation rate, resolution rate, etc.). The classified LLMs, conversations, inputs, and/or responses are further clustered based on various attributes. In various example, clusters are generated based on one or more or a number of previous conversations for a query source, a topic of the conversation, a language of the conversation, a service type associated with the conversation, etc.

If the conversation does not satisfy the criterion, a response is generated to the input using the first model (Operation 218). For instance, a first LLM is used to create a reply based on the input due to the first LLM being a default LLM or due to the first LLM having been previously selected. This response generation involves feeding the input into the first LLM, which processes the information and produces an output using its pre-trained language capabilities. The result is then structured and/or formatted as a message in the conversation and presented to the user, maintaining the original conversation flow. In some embodiments, the input is processed to result in and/or included with a prompt that is provided to the first LLM.

The system generates an answer to the present input that is based on the second output (Operation 220). If the conversation does not satisfy the criterion, the answer is based on the output of the initial model until a condition for changing to a different model is met.

The system collects one or more metrics for the first model based on one or more properties of subsequent input (Operation 222). For example, the system analyses the input to identify direct feedback or indirect feedback based on the input and the conversation.

The system evaluates the first mode and/or the second model based on the one or more metrics for the first model (Operation 224). In an example, the system compares a metric for the first LLM to a metric for the second LLM (or another model), or to a standard for the metric type. For example, the system compares a success rate, an escalation rate, or a feedback rate metric for the first model and the second model.

The system aggregates and/or groups one or more metrics for the first model into classes and/or clusters (Operation 226). For example, the system uses the collected metrics to aggregate and/or correlate the one or more metrics for the conversation with one or more comparable metrics collected for one or more other conversations. These other conversations include responses having content generated by the first LLM, the second LLM, or another LLM.

The system selects a model from a plurality of models based on a score for an aggregated metric based on a subsequent input having an attribute associated with the aggregated metric (Operation 228). In this example, the system determines a number of previous conversation associated with the source, a topic of the conversation, a location of the source, a language of the source, a service type associated with the conversation, and/or another attribute of or associated with the input. The system determines an LLM having a best score (e.g., a highest success rate, a lowest escalation rate, a greatest or highest percentage feedback score, etc.).

The system accesses feedback associated with a plurality of conversations (Operation 230). The system retrieves user feedback directly using stars, scores, “thumbs-up”/“thumbs-down,” positive or negative, or other types of feedback. In various embodiments, the feedback includes ratings, comments, and/or qualitative assessments. This feedback is gathered from sources such as post-interaction surveys, user-generated remarks, or automated sentiment analysis tools. The collected feedback is then prepared for further processing, such as by filtering relevant data or organizing the data for effective model training. In embodiments, the feedback is collected based on contents of one or more queries in a conversation. For example, whether a query was repeated is considered as a type of (negative) feedback, and whether a query was a final query in a conversation is considered as another type of (positive) feedback.

The system trains or fine-tunes one or more models using the feedback as training data (Operation 232). For example, the system uses the feedback to adjust the parameters or improve the performance of the first LLM or the second LLM (or another LLM). In some embodiments, the system optimizes an LLM using a supervised learning or reinforcement learning process whereby an LLM learns from comparing output to a ground truth or adapts based on feedback indicating success or failure of prior outputs. The outcome of this fine-tuning is an updated LLM. The updated LLM is used in place of the first LLM or the second LLM to collect metrics for the updated LLM to compare to the first LLM or the second LLM to verify improved performance of the updated LLM.

In some embodiments, an escalation metric is used as the training data. In cases where a conversation is escalated to a human agent, the answer generated by the human agent is collected and used as training data. A semantic check between the contents of the conversation prior to escalation and the contents of the human answer is used to filter false negative escalation feedback. For example, in the case that a user escalates a conversation to a human agent, but a query has already been answered with the same content in the conversation prior to the escalation, the conversation is not counted as negative feedback despite being escalated. The human response and/or the generated response are added to a knowledge base in a data entry corresponding to the query and/or the conversation.

### 4. Example Techniques for Adaptive Query Response

i. Overview of Example Techniques

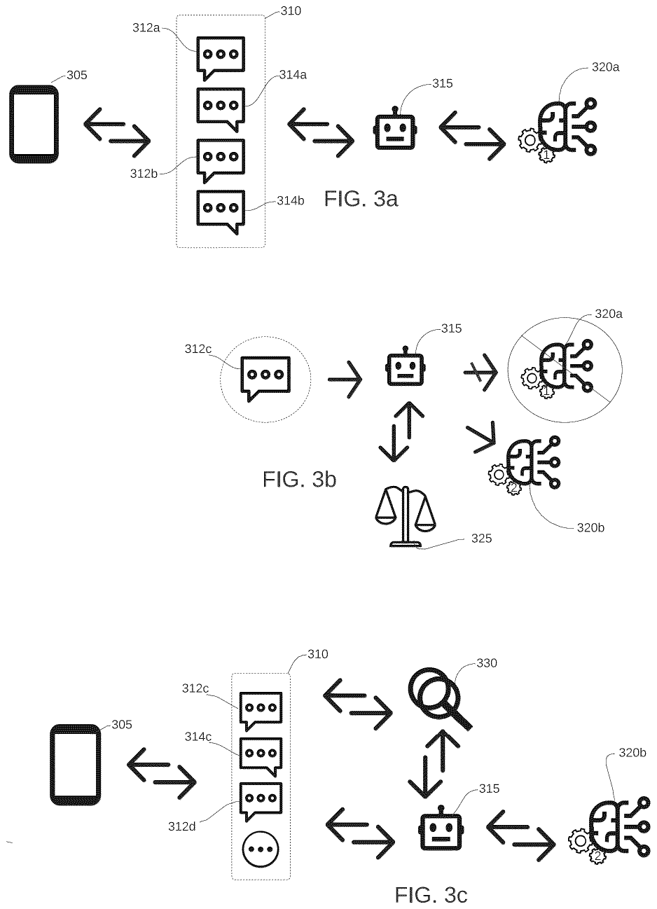

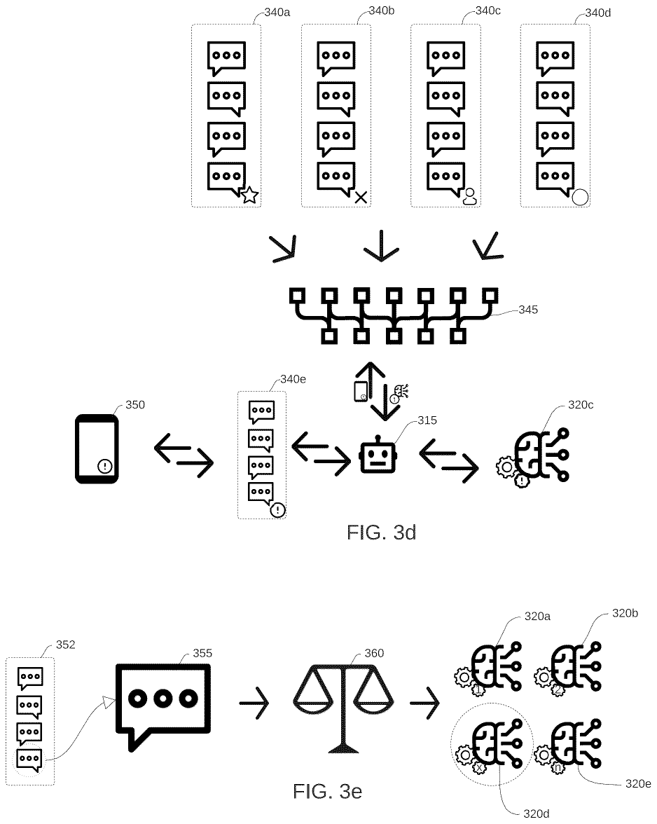

FIGS. 3a-e illustrate example techniques for adaptive query response, in accordance with one or more embodiments. For example, the example system performs the techniques to determine an LLM that is deployed during use or production of the system and/or associated devices.

In FIG. 3a, a client device 305, such as a smartphone or computer, provides input to a conversation 310. In the example, the input includes a first query 312a and a second query 312b, which are transmitted from the client device 305 into the conversation 310. The client device 305 serves as the interface for user interaction, enabling the user to input the queries through text, voice, or other supported methods. These inputs are formatted as part of the conversation 310 for processing by downstream components.

In various embodiments, a chatbot 315 provides a first response 314a to the first query 312a and a second response 314b to the second query 312b in the conversation 310. The chatbot 315, which operates as a local or web-based application or service, accesses the queries in the conversation 310 and generates responses. In this process, the chatbot 315 interacts with backend systems to process the inputs and deliver responses tailored to the respective queries. These responses, including the first response 314a and the second response 314b, are incorporated into the conversation 310 for presentation to the user.

In the example, the chatbot 315 uses a first LLM 320 to generate the responses 314a and 314b to the respective queries 312a and 312b. Specifically, the chatbot 315 invokes the first LLM 320a to process the queries and produce corresponding answers. The first LLM 320a analyzes the input text from the conversation 310 and generates contextually appropriate responses based on its trained data. These responses are then formatted and presented within the conversation 310.

In FIG. 3b, a particular input 312c is accessed by the chatbot 315. Responsive to one or more criteria being met, the chatbot 315 generates a prompt for a second LLM 320b instead of or in addition to the first LLM 320a. In a particular embodiment, the second LLM 320b is a fine-tuned version of the first LLM 320a. In various embodiments, the second LLM 320b is randomly selected a percentage of the time (i.e., based on a probability for the first LLM 320a and the second LLM 320b). The percentage is adjusted to be higher if the conversation is successfully completed using the second LLM 320b. The percentage is adjusted to be lower if the conversation is escalated while using the second LLM 320b.

In embodiments, an evaluation model 325 evaluates the query and indicates to the chatbot 315 whether the first LLM 320a or the second LLM 320b should be used to generate a response to the particular input 312c. The evaluation module 325 analyzes the input 312c to detect the presence of feedback indicators, keywords, repeated questions, or the like. In some embodiments, the evaluation module 325 identifies an LLM based on one or more properties of the input 312c.

In FIG. 3c, the particular input 312c has been input into the conversation 310 by the client device 305. In this example, the chatbot 315 uses the second LLM 320b to generate the response 314c. A subsequent input 312d has been input into the conversation 310 by the client device 305. An input analyzer 330 analyzes the subsequent input 312d and records one or more metrics for the subsequent input 312d. In various embodiments, the input analyzer records metrics including whether the conversation is escalated or resolved, or whether positive or negative feedback is received, etc.

In various embodiments, the input analyzer identifies one or more attributes associated with the conversation 310, the particular input 312c, the response 314c, and/or the subsequent input 312d. For example, the input analyzer determines a topic, a service request type, an intention, a tone, or another attribute of the conversation 310 or one or more of the inputs 312c, 312d and/or the response 314 in the conversation 310. The input analyzer 330 collects metrics for the subsequent input 312d and/or other subsequent inputs. In embodiments, the input analyzer determines whether the input is positive or negative and provides this information to the chatbot agent 315. In an embodiment, a component of the chatbot agent 315 adjusts a probability of choosing the second LLM 320b to be higher based on a positive input and/or adjusts the probability of choosing the second LLM 320b to be lower based on a negative input.

In FIG. 3d, a first conversation 340a, a second conversation 340b, a third conversation 340c, and a fourth conversation 340d are input into an aggregator model 345. In the example, the first conversation 340 includes positive feedback. The second conversation 340b includes negative feedback. The third conversation 340c was escalated and includes human generated content. The fourth conversation 340d concluded with no subsequent query.

The aggregator model 345 clusters the conversations into one or more groups based on one or more metrics for the conversations. For example, a conversation is placed into a group based on whether the conversation was escalated, based on a number of previous conversations associated with the source of the query, a topic of the query, or the like.

In FIG. 3d, a client device 350 is used to input queries or other input into a fifth conversation 340e. The system selects a particular language model 320c based on an attribute of the client device, such as a number of conversations associated with the client device, or based on an attribute of the conversation, such as a topic of the conversation or whether a query is repeated in the conversation.

In FIG. 3e, a particular query 355 of a conversation 352 is evaluated by a query evaluator 360. In the example, the query evaluator 360 processes the query 355 by analyzing its features. The query evaluator 360 applies evaluation criteria and, based on the evaluation of the query 355, a particular LLM 320 is selected from a plurality of LLMs, including the first LLM 320a, the second LLM 320b, the particular LLM 320d, and one or more other LLMs 320e.

In the example, the query evaluator 360 utilizes the results of the query evaluation to identify the most suitable LLM 320 for generating responses. The selection may involve matching the identified attributes of the query 355 with an LLM having one or more best metrics associated with a group of conversations having one or more matching attributes of the query.

The query evaluator 360 determines that a different LLM should be selected based on the content of the query 355. In this example, the evaluation reveals that the current LLM is not optimal for further responses due to changes in query attributes or conversation dynamics. The query evaluator 360 evaluates the query 355 and identifies the particular LLM 320d for the query (and optionally subsequent queries). The transition to the particular LLM 320d is triggered based on predefined criteria or thresholds that the system determines are met by the evaluation of the query 355 and/or the conversation 352.

The particular LLM 320 is selected at random or based on one or more attributes of the query 355. In the example, the selection process involves either probabilistic methods or attribute-based matching, depending on the operational configuration of the system. For random selection, the system applies a weighted randomization to favor LLMs with higher prior performance. For attribute-based selection, the system analyzes aspects of the query 355, such as its topic or technical requirements, and determines an LLM with a highest success rate, a lowest escalation rate, etc.

In various embodiments, an LLM is selected based on a metric for one or more of: a user group metric, a user experience metric, an improvement metric, a regression metric, and/or a human agent alignment metric. In an embodiment, the system renders a graphical user interface that visualizes the various metrics in an interactive, explorable format for one or more LLMs, for example in a dashboard for model performance tracking and analytics. The aggregated data related to the conversations, LLMs, and corresponding feedback are explorable via the dashboard. The aggregated data and/or visualization facilitates automated and/or manual LLM selection in various deployment environments.

In embodiments, a first LLM is deployed as a primary LLM and one or more second LLMs are deployed as one or more secondary LLMs. The system replaces the primary LLM with a second LLM responsive to feedback and/or metrics indicating better performance for the second LLM. Once the primary LLM is changed, feedback is collected for the primary LLM (a second LLM) and one or more other second LLMs. The system replaces the primary LLM with an other second LLM responsive to feedback and/or metrics indicating better performance for the other second LLM. The system continues to collect feedback and/or metrics and replaces the primary LLM responsive to certain feedback and/or metrics in an iterative feedback loop, continuously enhancing the performance of the system. In embodiments, feedback is collected for one or more particular user groups, topics, services, etc. One or more different primary LLMs is deployed for one or more user groups, topics, services, etc. The one or more different primary LLMs are replaced with one or more other second LLMs responsive to feedback and/or metrics indicating better performance for the one or more other second LLMs for the one or more user groups, topics, services, etc.

ii. Metrics for User Groups

In an example, the system is used for testing for metrics for target user groups. For instance, customers of a service are segmented based on their usage patterns, including the specific products and/or services they use and the frequency of support sessions (i.e., conversations) they participate in via a chatbot, total service requests (SRs), or total interactions with human agents. Different customer groups are assigned different agents. One or more agents use a large language model (LLM). The one or more agents perform different actions in one or more of the following ways: 1. System Prompts: Initial instructions given to the LLM to set the context are different for an agent. 2. Chain of Thought Prompts: Agent-specific step-by-step reasoning prompts that enhance response quality. 3. Preambles: Agent-specific introductory text that sets the tone for the LLM's responses. 4. Pretrained Base LLM: A plurality of agents deploys different LLMs like Cohere, Llama 2, Llama 3, Mistral, etc. 5. Fine-Tuned LLMs: One or more versions of LLMs are customized for specific use cases using feedback-based optimization or fine-tuning. 6. Context Data Format: A plurality of agents deploy different formats like XML, Markdown, HTML, Raw Text, etc. 6. Frequently Asked Question (FAQ) Inclusion: Certain agents are infused with intents/utterances or FAQs to evaluate helpfulness in reduction of service request creation or human sessions (escalation). This allows in improvement of an FAQ platform's generation pipeline for the system by gathering feedback from a customer or user device in the evaluation phase.

In embodiments, metrics such as deflection rate (percentage of sessions handled without human intervention) and the number of sessions escalated to human agents or resulting in service requests (e.g., chatbot or human chat sessions) are monitored. These and/or other metrics are analyzed to identify the agent configurations that result in higher deflection rates and/or fewer escalations.

In various embodiments, metrics are determined for a first model and a second model that is randomly selected to complete a percentage of conversations initiated by the first model. A first plurality of metrics for a plurality of conversations completed by the first model and second plurality of metrics for a plurality of conversation initiated by the first model but completed by the second model are collected. The first plurality of metrics and the second plurality of metrics are used to evaluate and/or compare the models. By way of example, a first plurality of metrics indicates an escalation rate of 16% for the first model for conversations related to a user group and/or topic and a second plurality of metrics indicates an escalation rate of 4% for conversations related to the user group and/or topic that were initiated using the first model but for which a second model was selected by chance for one or more subsequent responses in the conversation. The lower escalation rate of the latter indicates superior performance of the second model for the user group and/or topic.

iii. Parallel Agents for User Experience Improvement

In some embodiments, the system deploys parallel agents to improve user experience. In this example, two agents, A1 (which utilizes an LLM) and A2 (which utilizes the LLM or another LLM), are deployed in parallel. In this example, user queries in conversations are sent to both A1 and A2. Initially, A1's responses are shown 75% of the time, and A2's responses 25% of the time. These are tunable probability of usage. In other embodiments, another probability is used (e.g., 90-10, 50-50, 25-75). In this example, the first response is A1's response to the user.

Responsive to a user repeating or rephrasing a question after receiving A2's response, the response is flagged as negative, and A2's response probability is halved until it reaches close to 0%. If a user continues the conversation after an A2 response, the response is flagged as positive, and A2's response probability is doubled until it reaches 100%. At the end of the conversation, the system determines A2's probability. Responsive to A2's response probability being at the initial 25% at the end of a conversation, the conversation is excluded from the resulting dataset for A2 since A2's responses were not shown to the user. Responsive to A2's probability being less than 25%, the system identifies an inconsistency with A1's response style. Alternatively a percentage higher than 25% indicates consistency. The responses are evaluated for answerability, grounding, citation, and faithfulness to ensure quality and prevent hallucinations.

iv. Parallel Agents for Evaluating Improvement

In some embodiments, parallel agents are deployed to evaluate improvement metrics. In this example, two agents, A1 (which utilizes an LLM) and A2 (which utilizes a tuned version of the LLM or another LLM to be tested for improvement), are deployed in parallel. In this example, user queries are sent to both A1 and A2. If the user gives a thumb-down or requests a refresh, A2's response is shown instead of A1's response, and A2 becomes the primary agent.

In the example, the conversation is continued until the user again rephrases his previous question or asks for a refreshed answer. Successful resolution or deflection of the conversation with A2 is considered an improvement in overall business metrics, indicating the new agent's effectiveness. The number of times A2 becomes the primary agent and remains the primary agent till the end of the conversation, is also computed across the sessions to compute % improvement.

v. Parallel Agents for Evaluating Regression

In embodiments, the system deploys parallel agents to evaluate regression. In this example, two agents, A1 (which utilizes the new or fine-tuned model being tested for regression) and A2 (which utilizes a base model), are deployed in parallel, with A1 initially treated as the primary agent. In this example, user queries are sent to both A1 and A2. If the user gives a thumb-down or requests a refresh, A2's response is shown, and A2 becomes the primary agent. Successful resolution or deflection of the conversation with A2 indicates regression in overall business metrics, as A1's effectiveness compared to A2 is lower. The number of times A2 becomes the primary agent and remains the primary agent computed across the sessions to compute a percentage of regressions.

vi. Human Agent Alignment

In embodiments, the system deploys parallel agents with a human agent. In this example, two agents, A1 (which utilizes the new or fine-tuned model being tested for regression) and A2 (which utilizes a base model), are deployed in parallel. In this example, the conversation is escalated to be resolved by a Human Support Agent, as both the A1 & A2 failed to resolve user query, resulting in the Human Support being triggered. In this example, both A1 and A2 continue to generate response to the user query, but the response of the Human Support Agent is shown to the user.

The answers from A1 and/or A2 are compared for semantic similarity with the Human Agent's answer. In this example, the semantic similarity score for A1 or A2 (or a score for both) is stored as a metric. Responsive to the answers from A1 and/or A2 differing from the Human Agent's answer, they are added to a rejected answer list. In some embodiments, a human agent verifies chatbot answers during the conversation. Based on the human agent approving or uses the chatbot agent's answer, the chatbot agent answer is added to an accepted answer list. In embodiments, the human answer is added to the accepted answer list. The list of rejected and/or accepted answers is used for aligning one or more models with techniques Direct Preference Optimization (DPO) or Off-Policy Reinforcement Learning (ORPO).

Aligning LLMs using DPO or ORPO involves using the accepted and rejected answers as training data. In DPO, a preference model is trained to rank outputs based on the lists, comparing pairs of responses to determine which is better. For example, a generative model, an agent model, an LLM, or another model is then fine-tuned to align its output probabilities to prefer accepted answers over rejected ones by optimizing for preference directly. Other approaches like ORPO use reinforcement learning to improve outputs by sampling responses, evaluating them with a reward function, and updating the model accordingly. These methods leverage the accepted/rejected answers to refine the model's behavior to maximize alignment with desired human-like outputs.

### 5. Machine Learning Architecture

FIG. 4 illustrates a machine learning engine 400 in accordance with one or more embodiments. As illustrated in FIG. 4, machine learning engine 400 includes input/output module 420, data preprocessing module 422, model selection module 424, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, Application Programming Interfaces (API)s, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 422 transforms data into a format suitable for use by other modules in machine learning engine 400. For example, data preprocessing module 422 may transform raw data into a normalized or standardized format suitable for training ML models and for processing new data inputs for inference. In an embodiment, data preprocessing module 422 acts as a bridge between the raw data sources and the analytical capabilities of machine learning engine 400.

In an embodiment, data preprocessing module 422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 422 may be configured to handle anomalies in different ways depending on context. Data preprocessing module 422 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 422 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 422 processes new data for inference, data preprocessing module 422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 424 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 424 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 424 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 424 also considers computational efficiency and resource constraints. This is meant to help ensure the selected model is both accurate and practical in terms of computational and time requirements. In an embodiment, certain features of model selection module 424 are configurable such as a configured bias toward (or against) computational efficiency.

In accordance with an embodiment, training module 426 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

### 6. Machine Learning Operations

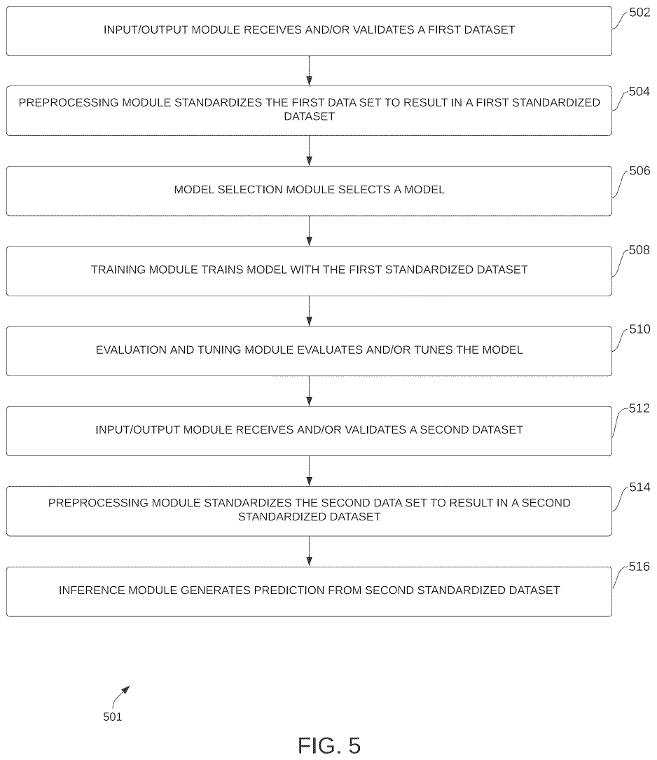

FIG. 5 illustrates a set of machine learning operations 500. In embodiments, one or more operations of the set of operations 500 is performed by a machine learning engine such as machine learning engine 400. In an embodiment, input/output module 420 receives a dataset intended for training (Operation 502). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 422. Here, the data undergoes a series of transformations to standardize and clean it, making it suitable for training ML models (Operation 504). This involves normalizing numerical data, encoding categorical variables, and handling missing values through techniques like imputation.

In an embodiment, prepared data from the data preprocessing module 422 is then fed into model selection module 424 (Operation 506). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 508). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 510). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 512).

In an embodiment, data preprocessing module 422 receives the validated dataset intended for inference (Operation 514). Data preprocessing module 422 ensures that the data format used in training is replicated for the new inference data, maintaining consistency and accuracy for the model's predictions.

In an embodiment, inference module 430 processes the new data set intended for inference, using the trained and tuned model (Operation 516). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as /submitData facilitate the submission of new data for processing, while /retrieveResults is designed for fetching the outcomes of data analysis or model predictions. The message level encryption (MLE) API also includes endpoints like /updateModel for model modifications and /trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

### 7. Generative Artificial Intelligence Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a “SoftMax” function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 412, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 414 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 416, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 418, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 422 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 242, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a taxonomic negative sampling-based machine learning system via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a taxonomic negative sampling-based machine learning system may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Microservice Applications

According to one or more embodiments, the techniques described herein are implemented in a microservice architecture. A microservice in this context refers to software logic designed to be independently deployable, having endpoints that may be logically coupled to other microservices to build a variety of applications, for example, by logically coupling a taxonomic negative sampling-based machine learning system to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 10. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

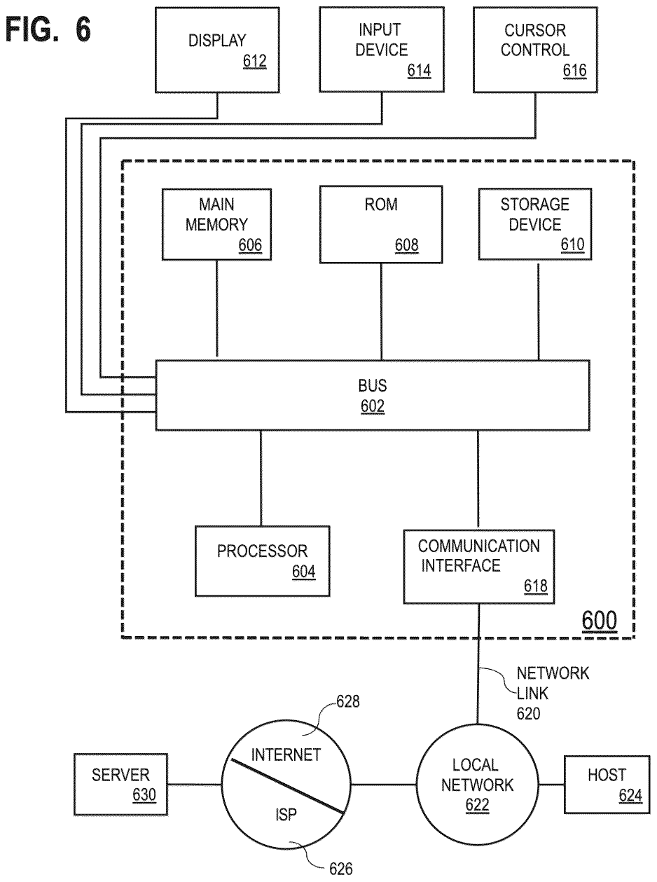

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 11. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. A method of generating a metric for a large language model (LLM) by an adaptive query response system, comprising:
accessing, by a generative model adaption engine of the adaptive query response system, a conversation, record stored in a data repository of the adaptive query response system, wherein the conversation comprises a present input, one or more initial inputs from a source to an agent and one or more initial responses from the agent to the source, wherein the one or more initial responses are based on one or more initial outputs generated by a first LLM;
responsive to the conversation record satisfying a criterion by a query evaluator of the adaptive query response system:
generating, by a prompt generator of the generative model adaption engine, a prompt for a second LLM based on the present input;
accessing a first output of the second LLM that is output by the second LLM in response to the prompt; and
presenting, in the conversation, an answer based on the first output;
collecting, by a metric evaluator of the adaptive query response system, a metric based on a property of a subsequent input from the source to the agent in the conversation record;
evaluating the second LLM based on the metric by updating model performance data associated with the second LLM in the data repository; and
training or fine-tuning, by the adaptive query response system, at least one of the first LLM or the second LLM using feedback derived from the metric and the model performance data, wherein the training adjusts one or more parameters of the at least one LLM to improve subsequent outputs;
wherein the method is performed on at least one device comprising a hardware processor.

2. The method of claim 1, further comprising:
identifying a group corresponding to the source based on an attribute of the source;
selecting the second LLM from a plurality of LLMs based on the group;
aggregating the metric with a second metric collected for a second source in the group to result in an aggregated metric for the group; and
evaluating the second LLM for the group based on the aggregated metric for the group.

3. The method of claim 2, wherein:
the aggregated metric comprises a conversion metric, an escalation metric, a feedback metric, a semantic similarity metric, or a specified metric.

4. The method of claim 2, wherein:
the group is defined based on at least one of a client type, input type, conversation topic, or location of the source.

5. The method of claim 2, wherein:
the group is identified based on at least one of: a number of conversations between the source and the agent, one or more types of services associated with generating a particular answer of a particular conversation, and a format associated with generating the particular answer of a particular conversation.

6. The method of claim 1, wherein:
the input is a first input;
the method further comprising:
accessing a second input;
randomly selecting a randomly selected LLM from the first LLM and the second LLM using a probability for selecting the first LLM and the second LLM;
generating a second prompt, based on the second input, for the randomly selected LLM;
accessing a second output of the randomly selected LLM that is output by the randomly selected LLM in response to the second prompt;
collecting a second metric based on a second property of a second subsequent input from the source to the agent in the conversation; and
evaluating the at least one of the first LLM and the second LLM based on the second metric.

7. The method of claim 6, further comprising:
adjusting the probability in a direction corresponding to a polarity of feedback received for at least one of the first LLM and the second LLM.

8. The method of claim 1, wherein:
the conversation satisfies the criterion responsive to a portion of the conversation indicating negative feedback was received for the one or more initial responses.

9. The method of claim 1, wherein:
the prompt is a first prompt;
the method further comprising:
accessing a second input;
generating a second prompt based on the second input;
accessing a second output of the second LLM that is output in response to the second prompt;
accessing a third output of the first LLM that is output in response to the second prompt; and
generating a second answer using a selection of the second output and the third output that is based on an evaluation of the second output and the third output.

10. The method of claim 1, wherein:
the first LLM is a base LLM and the second LLM comprises a selection from: a fine-tuned version of the base LLM, a different-sized LLM, or a different family of LLM.

11. The method of claim 1, wherein:
the prompt includes the one or more initial inputs and the one or more initial responses as context.

12. The method of claim 1, wherein:
the property of the subsequent input comprises at least one of: repeated content, positive feedback, negative feedback, a new topic, a neutral tone, a follow-up query, a change in conversation style, a change in theme, a reference to a previous response, and being null.

13. The method of claim 1, wherein:
the conversation is a first conversation of a plurality of conversations;
the method further comprising:
collecting a respective plurality of metrics for the plurality of conversations, the respective plurality of metrics comprising an indication of whether a final answer in the conversation included a final output from the first LLM or included a final output from the second LLM.

14. The method of claim 1, wherein:
the conversation is a first conversation of a plurality of conversations;
the method further comprising:
collecting a respective plurality of metrics for the plurality of conversations, the respective plurality of metrics comprising an indication of whether the plurality of conversations were escalated.

15. The method of claim 1, further comprising:
responsive to the present input containing negative feedback and the subsequent input containing a threshold of negative feedback: escalating the conversation from a chatbot to an expert; and
responsive to receiving an expert answer from the expert:
adding the expert answer to an accepted answer list;
responsive to the one or more initial responses corresponding to content of the expert answer: adding the response to the accepted answer list;
responsive to the one or more initial responses differing from content of the expert answer: adding the response to a rejected answer list;
responsive to the answer corresponding to content of the expert answer: adding the answer to the accepted answer list;
responsive to the answer differing from content of the expert answer: adding the answer to a rejected answer list; and
storing the accepted answer list and the rejected answer list; and
providing at least one of the accepted answer list and the rejected answer list as training data to at least one of the first LLM and the second LLM.

16. The method of claim 1, wherein:
the metric is a first metric;
the method further comprising:
accessing a second conversation;
responsive to a second input in the second conversation satisfying a second criteria:
generating a second prompt for the first LLM based on the second input;
accessing a second output of the first LLM that is output by the first LLM in response to the second prompt;
presenting, in the second conversation, a second answer based on the second output; and
collecting a second metric based on a property of a second subsequent input from the second conversation; and
evaluating the first LLM based on the first metric and second metric.

17. The method of claim 1, wherein:
the metric is a first metric;
the method further comprising:
comparing the first metric to a second metric for a third LLM to determine whether the second LLM or the third LLM is used to generate an answer to the subsequent input.

18. The method of claim 17, further comprising:
rendering a graphical user interface comprising a visual representation of at least one of the first metric and the second metric.

19. One or more non-transitory computer readable media comprising instructions which, when executed by one or more hardware processors, cause performance of operations comprising:
accessing, by a generative model adaption engine of the adaptive query response system, a conversation, record stored in a data repository of the adaptive query response system, wherein the conversation comprises a present input, one or more initial inputs from a source to an agent and one or more initial responses from the agent to the source, wherein the one or more initial responses are based on one or more initial outputs generated by a first LLM;
responsive to the conversation record satisfying a criterion by a query evaluator of the adaptive query response system:
generating, by a prompt generator of the generative model adaption engine, a prompt for a second LLM based on the present input;
accessing a first output of the second LLM that is output by the second LLM in response to the prompt; and
presenting, in the conversation, an answer based on the first output;
collecting, by a metric evaluator of the adaptive query response system, a metric based on a property of a subsequent input from the source to the agent in the conversation record;
evaluating the second LLM based on the metric by updating model performance data associated with the second LLM in the data repository; and
training or fine-tuning, by the adaptive query response system, at least one of the first LLM or the second LLM using feedback derived from the metric and the model performance data, wherein the training adjusts one or more parameters of the at least one LLM to improve subsequent outputs.

20. A system comprising:
at least one device including a hardware processor;
the system being configured to perform operations comprising:
accessing, by a generative model adaption engine of the adaptive query response system, a conversation, record stored in a data repository of the adaptive query response system, wherein the conversation comprises a present input, one or more initial inputs from a source to an agent and one or more initial responses from the agent to the source, wherein the one or more initial responses are based on one or more initial outputs generated by a first LLM;
responsive to the conversation record satisfying a criterion by a query evaluator of the adaptive query response system:
generating, by a prompt generator of the generative model adaption engine, a prompt for a second LLM based on the present input;
accessing a first output of the second LLM that is output by the second LLM in response to the prompt; and
presenting, in the conversation, an answer based on the first output;
collecting, by a metric evaluator of the adaptive query response system, a metric based on a property of a subsequent input from the source to the agent in the conversation record;
evaluating the second LLM based on the metric by updating model performance data associated with the second LLM in the data repository; and
training or fine-tuning, by the adaptive query response system, at least one of the first LLM or the second LLM using feedback derived from the metric and the model performance data, wherein the training adjusts one or more parameters of the at least one LLM to improve subsequent outputs.
